(19) United States
(12) Patent Application Publication
(10) Pub. No.: US 2025/0169525 A1
(43) Pub. Date: May 29, 2025

(54) PROCESS FOR THE MANUFACTURE OF A LEGUME-BASED FOOD PRODUCT

(71) Applicant: FÆRM ApS, København S (DK)

(72) Inventors: Andrea Donau Lauridsen, København S (DK); Astrid Bonke, København S (DK); Martina Gunilla Weibull, København S (DK); Sanne Pernov Tavares, København S (DK)

(73) Assignee: FÆRM ApS, København S (DK)

(21) Appl. No.: 18/841,010

(22) PCT Filed: Feb. 24, 2023
(86) PCT No.: PCT/EP2023/054688

§ 371 Date: Aug. 23, 2024

(30) Foreign Application Priority Data
Feb. 25, 2022 (EP) 22158886.6

(51) Int. Cl. A23L 11/50; A23L 29/00; A23L 29/231; A23L 29/256; A23L 33/21

(52) U.S. Cl. CPC A23L 11/50; A23L 29/06; A23L 29/065; A23L 29/231; A23L 29/256; A23L 33/21

(57) ABSTRACT

The present invention relates to a process of manufacturing a legume- based food product, the process comprising the steps of providing an aqueous legume fruit suspension, adding a lipid component to the aqueous legume fruit suspension, A adjusting the temperature of the aqueous legume fruit suspension to an enzyme treatment temperature, adding a coagulating enzyme to the aqueous legume fruit suspension, maintaining the aqueous legume fruit suspension containing the coagulating enzyme at the enzyme treatment temperature for a coagulating duration to provide a coagulated legume fruit suspension, inactivating the coagulating enzyme in the coagulated legume fruit suspension to provide a food product suspension, and removing liquid from the food product suspension to provide the legume- based food product.

### TECHNICAL FIELD

The present invention relates to a process for the manufacture of plant-based, meat- and dairy-free cheese alternatives and to a corresponding product. Thus, the invention provides a legume-based food product and a method for the manufacture thereof.

### Background Art

The market demand for meat- and dairy-free products is continuing to increase owing to more people choosing to reduce or eliminate meat and dairy products from their diet for health, environmental sustainability, and ethical reasons.

Plant-based cheese alternatives are one of the many new-emerging totally dairy-free products responding to the requirements of people who choose to predominantly eat plant-based food. Plant-based cheese alternative might also fit into the diets of people with special dietary needs such as those with cow milk allergy or lactose intolerance, and those with concerns about cow milk hormones.

Most of the commercial plant-based cheese alternatives are based on mixtures of water, protein and fat, and may further comprise starch. The starch used for these cheeses is often modified starch, which precludes their marketing as a “clean-label” product. Furthermore, of these commercial plant-based cheese alternatives have poor melting characteristics, do not display the stretch associated with conventional molten cheese, and can have an off-taste which thus requires the addition of further odours and flavours. Furthermore, the plant-based cheese alternatives typically have a lower nutritional value, e.g., calcium and protein content, than conventional dairy cheeses.

US 2022/030899 discloses a vegetable food product analogous to a fermented cheese and a method for preparing the product. The idea behind US 2022/030899 is to start from finely crushed nut purees, but when mixed with water, these introduce a technical problem. Thus, the suspension is very liquid, with a viscosity close to that of the milk, and the structuring of this mixture is a problem since the product must be textured within a few hours in order to make it demoldable and without the help of the caseins. US 2022/030899 identifies three ‘levers’ to solve the problem: using a transglutaminase enzyme, the addition of texturizing ingredients such as starch, and adding hard fats that will allow the solidification of the finished product during the crystallization of the fat. However, nuts are generally expensive, and a cheaper starting product is desirable.

WO 2018/115597 discloses a fermented food product comprising legume protein and oat preparation and being essentially soy-free and milk-free, and a process for the production of the product. For example, water, vegetable protein, fat and possible emulsifiers and taste enhancers are mixed, homogenised if necessary, then pasteurized and cooled to a fermentation temperature before addition of starter and enzyme, and the coagulate obtained via the fermentation can be cut into a suitable form, heated and separated from the fluid. The process uses a transglutaminase enzyme. The process unfortunately requires highly processed starting materials, e.g. pea protein isolates, which are not optimal for a price optimised industrial process.

US 2021/169096 aims to address the concern that plant-based substitutes of animal-based products may be subpar in nutrition or taste, and also prohibitively expensive and provides methods of manufacturing and compositions of plant-based food products such as cheese, milk, yogurt, egg, and tofu-replicas. US 2021/169096 thus discloses a composition comprising a plant-based fermentation product containing an oilseed material and a microorganism, e.g. a lactoacid bacterium and a method for forming a plant-based food product in which a oilseed seed material is comminuted to form the plant-based food product. The material may further comprise materials from nuts, soybeans, nuts, legumes, grains, flours, fats and oils, protein isolates, protein powders, spices, salts, gums, starches, amino acid isolates, flavouring, plant matter, microbial matter, and animal matter. The process may include curdling using a coagulating agent, such as proteases, an enzyme, bacteria, or fungus, thermally induced coagulation, salt coagulating agents or adding an acid to the material to induce coagulation.

To overcome the obstacle of the above-mentioned cheeses, an alternative approach may be to replace the conventional cheese composition ingredients with plant-based alternatives. Such replacements may, however, present several technical obstacles due to the possible incompatibility of a plant-based constituent with other constituents or manufacturing conditions required for the conventional cheese manufacturing methods.

Thus, there remains a need for improved methods of manufacturing cheese analogues which meet consumer expectations and display similar properties as those of conventional cheeses, including functional properties, such as melt, stretch, and firmness, organoleptic properties, such as texture and flavour, and nutritional properties.

### SUMMARY OF THE INVENTION

On this background it is an object of the present invention to provide a process for the manufacture of a legume-based food product, the process comprising the steps of:
providing an aqueous legume suspension, e.g. a legume fruit suspension, having a dry-matter content in the range of 50 g/L to 250 g/L;
adding a lipid component to the aqueous legume suspension in an amount of the lipid component in the range of 1% (VN) to 40% (VN) to total volume of the aqueous legume suspension and the lipid component;
adjusting the temperature of the aqueous legume suspension to a thermal treatment temperature, e.g. a thermal treatment temperature in the range of 30° C. to 90° C.;
adding a coagulating enzyme to the aqueous legume suspension and maintaining the aqueous legume suspension containing the coagulating 40 enzyme for a coagulating duration, e.g. in the range of 5 minutes to 120 minutes, to provide a coagulated legume suspension;
inactivating the coagulating enzyme in the coagulated legume suspension to provide a food product suspension;
removing liquid from the food product suspension to provide the legume-based food product.

The process employs a legume fruit suspension. This may also be referred to as a legume suspension, and the two terms may be used interchangeably.

The process may also comprise the step of adjusting the temperature of the aqueous legume fruit suspension to an enzyme treatment temperature, which enzyme treatment temperature is in the range of 10° C. to 70° C., in particular when the enzyme treatment temperature is different from the thermal treatment temperature.

An aqueous legume fruit suspension is used in the manufacturing process. In the context of the present disclosure, the term aqueous legume suspension means a suspension of legume matter in water. The aqueous legume suspension may also comprise dissolved components from the legume, in particular from the legume fruit. Correspondingly, the aqueous legume suspension may also comprise further components, e.g. components of a non-legume origin, added to the aqueous legume suspension. Relevant components include salts, e.g. inorganic salts, pH adjusting components, e.g. acids or bases, although the components are not limited to these.

In general, the aqueous legume suspension, e.g. the legume fruit suspension, may be described in terms of dry matter, especially dry legume matter, and the dry-matter content in the aqueous legume suspension is in the range of 50 g/L to 250 g/L. However, it is also contemplated that the dry-matter content of the aqueous legume suspension may be outside this range. For example, the dry-matter content of the aqueous legume suspension may be in the range of 10 g/L to 500 g/L.

The aqueous legume suspension may be a commercially available legume suspension, e.g. a legume-based drink, such as e.g. soy drink, also referred to as soy milk. Such commercially available legume suspensions, a legume-based drink, may be used directly, without the need for pre-processing, with the process according to the first aspect of the invention.

Alternatively, the aqueous legume suspension is prepared as part of the manufacturing process for the legume-based food product. Thus, in one embodiment, the step of providing an aqueous legume suspension comprises the steps of providing a legume fruit, in particular a dry legume fruit, disrupting the legume fruit, suspending the legume fruit in water to provide a legume suspension, and heating the legume suspension to a temperature in the range of 50° C. to the boiling point of water for a hydrating duration to provide the aqueous legume suspension. In the present context, the step of treating the legume fruits at the temperature in the range of 50° C. to the boiling point of water for the hydrating duration may also be referred to as a “blanching step”, regardless of the temperature used. Likewise, the legume fruits treated in the blanching step may be referred to as “blanched legume fruits”, and the temperature used may be referred to as the “blanching temperature”. It is generally preferred that legume fruits are initially subjected to the blanching step before disrupting the blanched legume fruits. For example, the legume fruits may be blanched in water, e.g. for a hydrating duration in the range of 5 minutes to 60 minutes, before disrupting, e.g. blending, the blanched legume fruits. Prior to disruption, the blanched legume fruits may be removed from the water used in the blanching step before resuspending the blanched legume fruits in water, in particular water that has not been used in the blanching step. The blanched legume fruits may be suspended in water, e.g. fresh water, at a content, compared to the original dry weight of the legume fruit before suspending in water, in the range of 50 g/L to 250 g/L, e.g. 80 g/L to 120 g/L, before disrupting, e.g. blending, the blanched legume fruit.

The present disclosure thus also provides a process for the manufacture of a legume-based food product, the process comprising the steps of:
providing a legume fruit;
disrupting the legume fruit;
suspending the legume fruit in water to provide a legume suspension;
heating the legume suspension to a blanching temperature in the range of 50° C. to the boiling point of water for a hydrating duration to provide the aqueous legume suspension;
adding a lipid component to the aqueous legume suspension in an amount of the lipid component in the range of 1% (VN) to 40% (VN) to total volume of the aqueous legume suspension and the lipid component;
adjusting the temperature of the aqueous legume suspension to a thermal treatment temperature, e.g. a thermal treatment temperature in the range of 30° C. to 90° C.;
adding a coagulating enzyme to the aqueous legume suspension and maintaining the aqueous legume suspension containing the coagulating enzyme for a coagulating duration, e.g. in the range of 5 minutes to 120 minutes, to provide a coagulated legume suspension;
inactivating the coagulating enzyme in the coagulated legume suspension to provide a food product suspension;
removing liquid from the food product suspension to provide the legume-based food product.

In a specific example, the process comprises the steps of:
providing a legume fruit;
suspending the legume fruit, e.g. at a dry-matter content in the range of 50 g/L to 250 g/L, in water and soaking the legume fruits for at least 1 hour at ambient temperature;
blanching the legume fruit at a blanching temperature in the range of 50° C. to the boiling point of water for a hydrating duration, e.g. a hydrating duration in the range of 5 minutes to 60 minutes, to provide blanched legume fruit;
disrupting the blanched legume fruits and suspending the blanched legume fruit in water to provide a legume suspension;
adding a lipid component to the aqueous legume suspension in an amount of the lipid component in the range of 1% (VN) to 40% (VN) to total volume of the aqueous legume suspension and the lipid component;
adjusting the temperature of the aqueous legume suspension to a thermal treatment temperature, e.g. a thermal treatment temperature in the range of 30° C. to 90° C.;
adding a coagulating enzyme to the aqueous legume suspension and maintaining the aqueous legume suspension containing the coagulating enzyme for a coagulating duration, e.g. in the range of 5 minutes to 120 minutes, to provide a coagulated legume suspension;
inactivating the coagulating enzyme in the coagulated legume suspension to provide a food product suspension;
removing liquid from the food product suspension to provide the legume-based food product.

The present disclosure provides a legume-based food product and a process for the manufacture of a legume-based food product. Legumes, i.e. plants of the family Fabaceae (or Leguminosae), commonly have dry fruits in pods. The present method employs a legume fruit, and in the context of the disclosure the legume fruit may also be referred to as a “legume” or a “fruit of a legume”, and the terms “legume”, “fruit of a legume” and “legume fruit” may be used interchangeably. In particular, when a legume is mentioned in the context of the method or the product, it is to be understood that the legume is the fruit of a legume. The legume may be any legume, in particular any legume considered for human consumption. Common legumes include alfalfa, clover, peas, beans, lentils, lupins, mesquite, carob, soy, and peanuts. More specifically legumes include dry beans (Phaseolus spp. including several species now in Vigna), such as kidney bean, haricot bean, pinto bean, navy bean (Phaseolus vulgaris), lima bean, butter bean (Phaseolus lunatus), azuki bean, adzuki bean (Vigna angularis), mung bean, golden gram, green gram (Vigna radiata), black gram, urad (Vigna mungo), scarlet runner bean (Phaseolus coccineus), ricebean (Vigna umbellata), moth bean (Vigna acontifolia), tepary bean (Phaseolus acutifolius); dry broad beans (Vicia faba), such as horse bean (Vicia faba equina), broad bean (Vicia faba), field bean (Vicia faba); dry peas (Pisum spp.), such as garden pea (Pisum sativum var. sativum), protein pea (Pisum sativum var. arvense); chickpea (Cicer arietinum), dry cowpea (Vigna unguiculata), pigeon pea (Cajanus cajan), lentil (Lens culinaris), peanut (Arachis hypogaea), lupins (Lupinus spp.), soy (Glycine max).

Legumes generally contain lectins, and certain legumes contain lectins that are toxic to humans. For legumes containing toxic lectins, the toxic lectins should be inactivated in the food product. In general, the step of heating the legume suspension to a temperature in the range of 50° C. to the boiling point of water for a hydrating duration, e.g. the blanching step, denatures toxic lectins to remove their toxicity.

Legume fruits are generally harvested in a dry form, and in the dry form the legume fruit may also be referred to as a “pulse”.

The legume fruit is disrupted in the present method. The disruption may be any processing intended to reduce the size of parts or particles of a plant material, e.g. a legume, in particular a legume fruit, and typical disruptive processing involves cutting, pressing, chopping, milling, grinding, crushing, grating, shredding etc. In particular the disruption aims to degrade or disrupt the cell walls of the plant material to make the contents of the cells accessible, especially to being hydrated. It is preferred to disrupt the legume fruit after blanching. By disrupting the legume fruit after blanching, subsequent removal of unwanted components, e.g. insoluble fibres and other insoluble components, is simplified, since the blanching will separate the insoluble components from the legume fruits and thereby minimise disruption of the insoluble components.

The steps of the present method are performed at specified temperatures. The temperatures include ambient temperatures. In the present context, an “ambient temperature” generally means the temperature existing in the surroundings. The ambient temperature may for example be any temperature in the range of 10° C. to 40° C.

The method of the present disclosure employs an aqueous legume fruit suspension. In general, the legume fruit suspension is provided from legume fruits in a dry form. Thus, the aqueous legume fruit suspension may also be referred to as an “aqueous legume fruit suspension”. It is to be understood that a “legume fruit suspension” can be a suspension of a legume fruit in any form, e.g. a suspension of whole legume fruits, disrupted legume fruits, comminuted legume fruits, particles of a legume fruit, etc. In the present context, the term “legume fruit” means that the legume fruit has been removed from its pod. It also preferably means that no components are removed from the legume fruit with the aid of a solvent. Thus, a legume fruit may have components removed while still in its dry form. It is especially relevant that the aqueous legume fruit suspension is not provided from a specific isolate of a component from the legume, e.g. a protein isolate. If a legume protein isolate is used to prepare the aqueous legume fruit suspension it is not possible to obtain desirable functional properties, such as meltability, stretch, and firmness, for the product thus obtained. Thus, in general legume protein isolates, or isolates from other legume components, e.g. starch, cannot be used to provide an aqueous legume fruit suspension for use in the present method. However, the legume fruit suspension may also be referred to as a legume suspension, but it is preferred that the aqueous legume suspension is an aqueous legume fruit suspension. It is further preferred that the legume is not employed as a specific isolate, e.g. as a legume protein isolate or a legume starch isolate.

In a specific example, the legume fruits are provided in a dry form, and the dry legume fruits are suspended in water and soaked in the water for at least 1 hour at ambient temperature, e.g. a temperature in the range of 10° C. to 40° C. There is generally no upper limit to the soaking time, but the soaking time may for example be in the range of 2 hours to 48 hours. After soaking, the soaked legume fruits may be disrupted, e.g. by wet milling. The disrupted wet legume fruits may then be heated to a temperature in the range of 50° C. to the boiling point of water. Alternatively, soaked legume fruits are blanched before being disrupted. It is generally preferred to boil the soaked legume fruits. When the legume fruits are heated to a temperature of at least 50° C., in particular to a temperature of at least 80° C. or least 90° C., the protein in the legume fruits, especially lectins, is generally denatured.

Legume fruits have high contents of proteins and lipids and also contain sugars. The sugars are commonly present as oligo- and polysaccharides which may be found as soluble or insoluble fibres. For example, the sugars may be starch, which is generally a mixture of amylose and amylopectin; these are both complex carbohydrate polymers of glucose. Starch is a fibre which is insoluble in cold water but which swells upon increase to a high temperature, e.g. at or above 50° C.

Without the wish to be bound by any particular theory, the present inventors believe that the presence of soluble oligo- and polysaccharide fibres contribute to the functional properties, such as meltability, stretch, and firmness, of the food product to thereby make the food product's properties more similar to the functional properties of a milk-based cheese. Thus, the use of legume fruits in the present method, e.g. as compared to using a legume protein isolate, is particularly advantageous for manufacturing a legume-based food product resembling a milk-based cheese, e.g. with respect to the functional properties of legume-based food product. It is preferred that the method does not comprise a step to remove soluble oligo- and polysaccharide fibres from the legume. In a specific example, the process comprises the step of adding a soluble fibre component, e.g. a soluble oligo- and polysaccharide fibre, to the aqueous legume suspension. In particular, the soluble fibre component may be added to the aqueous legume suspension before adjusting the temperature of the aqueous legume suspension to a thermal treatment temperature. The soluble fibre component may be added in the range of 0.1 g/L to 50 g/L. In an embodiment, the soluble oligo- and polysaccharide fibres is selected from agar agar, guar gum, alginate, amylose, starch, xanthan gum, pectin and gellan gum and any combination thereof. In an embodiment, the soluble oligo- and polysaccharide fibres is selected from agar, alginate, pectin and carrageenan and any combination thereof. In an embodiment, the soluble oligo- and polysaccharide fibres is carrageenan. In the context of the present invention, the term “meltability” refers to the legume-based food product's ability to melt and solidify when subjected to heating and cooling, respectively.

Without being bound by theory, the present inventors believe that by employing legume fruits, i.e. as an aqueous legume fruit suspension, combined with controlling the coagulating enzyme as described above provides a coagulated product from which excess water can easily be removed to provide a legume-based food product having a high content of proteins, lipids and other nutrients relative to the amount of water in the food product. In contrast, when the enzymatic treatment is not controlled, the inventors have found that a cheese-like legume-based food product cannot be obtained, or the product will have an unnecessarily high content of water. Thus, when the coagulating enzyme is a protease, and the enzymatic treatment is not controlled, a coagulate could not be formed. When the coagulating enzyme is a transglutaminase, and the enzymatic treatment is not controlled, i.e. when the transglutaminase is not inactivated appropriately, a coagulate will form from which water cannot easily be removed, and the product will have a correspondingly low content of proteins, lipids and other nutrients.

A lipid component is added to the legume suspension. The term “lipid component” is to be understood broadly, and it can mean a triglyceride, a free fatty acid or a combination thereof. Likewise, the lipid component may also be a glycerol backbone with one or two fatty acid chains, e.g. a monoglyceride or a diglyceride. The lipid component may have a low melting point so that it is a liquid oil at ambient temperature or it may have a melting point to be solid at ambient temperature, e.g. a fat. The lipid component may be a vegetable oil and or fat and/or an animal oil and or fat. It is preferred that the lipid component is derived from plants, e.g. a vegetable oil. The vegetable oil may be rapeseed oil, linseed oil, sunflower oil, soybean oil and/or hardened oils like hardened palm oil or hardened rape seed oil. It is preferred that the lipid component contains polyunsaturated fatty acids, especially long chained polyunsaturated fatty acids. It is preferred that the lipid component is an oil, especially an oil derived from plants, which is liquid at ambient temperature, e.g. at a temperature below 10° C., or a temperature below 20° C., or below 30° C. The present inventors have found that the functional properties of the legume-based food product more closely resemble the properties of a milk-based cheese compared to when the lipid component is solid at ambient temperature. Without being bound by theory, the present inventors believe that a liquid lipid component will be more intimately mixed with the legume fruit particles at an earlier stage in the process to thereby improve the functional properties of the legume-based food product produced in the process. Thus, in an example, the lipid component is an oil, which is liquid at ambient temperature. In a specific example, a lipid component that is solid at ambient temperature is not used in the process. In a further specific example, the lipid component is liquid at ambient temperature, e.g. below 30° C., or below 20° C., and the lipid component does not comprise a lipid that is solid at ambient temperature, e.g. below 30° C., or below 20° C.

The lipid component is added to the legume suspension in an amount in the range of 1% (VN) to 40% (V/V) lipid component to total volume of the aqueous legume suspension and the lipid component. In the context of the present disclosure, the term % (V/V) refers to the volume of a component added to a liquid relative to the total volume of the component and the liquid. However, the amount of the lipid component may also be expressed in terms of weight per volume, e.g. g/L. When the amount of the lipid component is expressed in g/L, the weight of the lipid component is compared to the volume of the aqueous legume suspension before adding the lipid component. Thus, the lipid component may be added to the aqueous legume suspension in an amount in the range of 9 g/L to 360 g/L. The lipid component is, without being bound by any theory, is believed to contribute to the meltability. In particular, the lipid component is believed to function together with the products of the enzymatic treatment to provide meltability to the legume-based food product. In general, a lipid component content of 9 g/L is sufficient to provide a desirable meltability. However, the meltability generally improves with the content of the lipid component. It is therefore preferred that the content of the lipid component in the aqueous legume suspension is at least 100 g/L, at least 150 g/L, at least 200 g/L, or at least 250 g/L. For example, the lipid component may be added to the aqueous legume suspension in an amount of the lipid component to the aqueous legume suspension in the range of 150 g/L to 360 g/L.

The temperature of the aqueous legume suspension is adjusted to a thermal treatment temperature. In the process, a coagulating enzyme is added to the aqueous legume suspension, and the coagulating enzyme is allowed to act on the aqueous legume suspension and provide a coagulated legume suspension. The coagulating enzyme typically has an optimum temperature at which its coagulating function works better than at other temperatures, and the thermal treatment temperature may be a temperature relevant for the coagulating enzyme. However, the present inventors have now surprisingly found that treatment at the thermal temperature prepares the legume fruit for treatment with the coagulating enzyme. Thus, in an example, the process comprises the step of adjusting the temperature of the aqueous legume suspension to a pre-heating temperature in the range of 30° C.-70° C. for optimal conditions for the chosen enzyme for a thermal treatment duration, e.g. in the range of 5 minutes to 30 minutes, such as in the range of 10 minutes to 25 minutes, such as in the range of 15 minutes to 30 minutes. In an embodiment, the pre-heating temperature in the range of 30° C.-70° C. is kept for a pre-heating duration of in the range of 20 minutes to 30 minutes. In another example, the process comprises the step of adjusting the temperature of the aqueous legume suspension to a thermal treatment temperature in the range of 70° C.-90° C. for a thermal treatment duration, e.g. in the range of 30 minutes to 90 minutes, such as in the range of 30 minutes to 80 minutes, such as in the range of 40 minutes to 80 minutes, such as in the range of 45 minutes to 60 minutes. In particular, the coagulating enzyme is preferably added after the thermal treatment duration. Without wishing to be bound by any particular theory, the present inventors believe that treatment at the thermal treatment temperature for the thermal treatment duration improves the accessibility of the coagulating enzyme to the substrate, e.g. the protein, of the coagulating enzyme. This is believed to be especially relevant as the legume fruit suspension contains other components, e.g. legume derived components, than proteins, e.g. polysaccharides and oligosaccharides, especially soluble polysaccharides and oligosaccharides. Thereby, using the thermal treatment temperature with the legume fruit suspension is especially advantageous in the preparation of a legume based food product when legume fruits are used. For example, the protein component of the legume suspension may be structurally opened so that the coagulating enzyme can more easily access the strands of the protein, which the coagulating enzyme acts upon. Thus, when the thermal treatment is performed, especially without addition of the coagulating enzyme, it is possible to prepare the protein component of the legume suspension for enzymatic treatment. In a specific example, the process comprises the step of adjusting the temperature of the aqueous legume suspension to an enzyme treatment temperature, e.g. an optimum temperature for the coagulating enzyme. The enzyme treatment temperature may be the same as the thermal treatment temperature, but preferably, the enzyme treatment temperature is different from, e.g. lower than, the thermal treatment temperature. For example, the thermal treatment temperature may be in the range of 30° C. to 90° C., e.g. 50° C. to 90° C., 70° C. to 90° C., or 75° C. to 90° C., and the enzyme treatment temperature, e.g. the optimum temperature for the coagulating enzyme, may be in the range of ambient temperature to 70° C. or more, e.g. in the range of 10° C. to 70° C. or in the range of 30° C. to 50° C.

Any component of the aqueous legume suspension may be involved in the coagulation, and the coagulating enzyme may be selected based on the component intended for coagulation. However, it is preferred that the coagulating enzyme acts on a protein component of the aqueous legume suspension. The coagulating enzyme may cleave strands of a protein, e.g. the coagulating enzyme may be a protease, or the coagulating enzyme may combine or cross-link, e.g. covalently link, strands of a protein. A coagulating enzyme capable of combining or cross-linking strands of a protein may be referred to as a cross-linking enzyme, e.g. a transglutaminase.

The coagulating enzyme has an optimum temperature, but in the context of the present disclosure, the thermal treatment temperature or the enzyme treatment temperature, e.g. when the temperature is adjusted from the thermal treatment temperature to the enzyme treatment temperature, may be any temperature in the temperature range, in which the coagulating enzyme is active. Such temperatures or temperature ranges are well known by a person skilled in the art. In general, the thermal treatment temperature is in the range of 30° C. to 90° C., e.g. in the range of 50° C. to 90° C. or 70° C. to 90° C., and the enzyme treatment temperature may be in the range of 20° C. to 70° C. In particular, the enzyme treatment temperature may be lower than the thermal treatment temperature.

In an embodiment, the coagulating enzyme is a cross-linking enzyme. In another embodiment, the coagulating enzyme is a protease. It is also contemplated that a cross-linking enzyme and a protease may be used together. Transglutaminases are examples of cross-linking enzymes and comprise a family of enzymes that catalyse the formation of a covalent bond between a free amine group of protein- or peptide-bound lysine (acyl acceptors) and the gamma-carboxamide group of protein- or peptide-bound glutamine (acyl donors). This results in the modification of proteins through either intra- or intermolecular cross-linking, thus improving the end use of the protein. Transglutaminases are used in conventional food processing, including dairy technology, to modify the functional properties of food proteins by catalysing the cross-linking of the proteins found in the substrate. In the context of the present disclosure, it is postulated that the transglutaminase catalyses the cross linking of the legume proteins present in the aqueous legume suspension, thus leading to a coagulated legume suspension. As an alternative to transglutaminase, proteases may also be used as a coagulating enzyme in the manufacturing process according to the invention. Proteases, also called peptidases or proteinases, are a family of enzymes which catalyse proteolysis, the process of breaking down proteins into shorter fragments, peptides or even into single amino acids. The two major groups are the exopeptidases, which target the terminal ends of proteins, and the endopeptidases, which target sites within proteins. In the context of the present disclosure, endopeptidases are preferred as coagulating enzyme. Fromase®, a commercial product of DSM, which is a range of microbial coagulants isolated from the fungus Rhizomucor miehei, represents a particular example of an endopeptidase which may be used as a coagulating enzyme for the manufacturing process disclosed herein. It is understood that the coagulating enzyme may be a mixture of several coagulating enzymes, such as e.g. a mixture of more than one endoprotease.

The coagulating enzyme may be from any source. For example, the coagulating enzyme may be obtained from a plant source, a microbial source or an animal source. Enzymes, including transglutaminases, especially enzymes obtained from plants and microbes, can generally comply with any religious or other requirement, and such enzymes may be classified according to halal or kosher requirements, or the enzymes may fulfil expectations of vegetarians and vegans. Thereby, the food product manufactured in the process, or the food product of the disclosure may be a vegan or vegetarian product, or the food product may be kosher or halal. In an example, the coagulating enzyme is produced recombinantly in a microorganism. Relevant coagulating enzymes are generally commercially available, and a list of relevant commercial enzymes are summarised in Table 1 with their tradename, the enzyme type and the name of the supplier.

TABLE 1
relevant commercial enzymes

| Name | Enzyme | Supplier |
|---|---|---|
| Microbial Rennet | Mucorpepsin | Hjemmeriet, Ringsted, |
| | | Denmark |
| Fermented Rennet | Chymosin | Hjemmeriet, Ringsted, |
| | | Denmark |
| Neutrase | Metallo proteinase | Novozymes A/S, |
| | (Zn) | Bagsværd, Denmark |
| Fromase 750 XLG | Microbial | DSM, Delft, Netherlands |
| | endopeptidase | |
| Fromase 220 XLG | Microbial | DSM, Delft, Netherlands |
| | endopeptidase | |
| Maxiren XDS | Chymosin | DSM, Delft, Netherlands |
| Transglutaminase | Transglutaminase | SARL Cuisine Innovation, |
| EB | | Dijon, France |
| Papain | Papain and | HerbaDiet, Arkure Health |
| | chymopapain | Care, Rohtak, India |
| Thermolase | Microbial | Chr. Hansen, Hørsholm, |
| | endothiapepsin | Denmark |
| CHY-MAX | Chymosin | Chr. Hansen, Hørsholm, |
| CHY-MAX supreme | | Danmark |
| CHY-MAX M | | |
| CHY-MAX special | | |
| Far-M | Fermented camel | Chr. Hansen, Hørsholm, |
| | chymosin | Danmark |
| CHY-MAX | Fermented | Chr. Hansen, Hørsholm, |
| Plus/Ultra/Extra | Chymosin | Danmark |
| Microlant | Microbial | Chr. Hansen, Hørsholm, |
| | mucorpepsin | Danmark |
| Hannilase | Microbial | Chr. Hansen, Hørsholm, |
| L/Microlant | mucorpepsin | Danmark |
| Hannilase | Microbial | Chr. Hansen, Hørsholm, |
| XP/Microlant | mucorpepsin | Danmark |
| Bromelain PNS 5 | Bromelain | Enzybel, Waterloo, |
| | | Belgium |
| Milase Premium | Fermented from | DSM, Delft, Netherlands |
| | Rhizomucor miehei | |
| NewBind | Transglutaminase | NewIngredients GmbH, |
| | | Witten, |
| | | Germany |
| Papain PNS 5 | Papain | Enzybel, Waterloo, |
| | | Belgium |
| Applicase | Bromelain | Enzybel, Waterloo, |
| | | Belgium |
| Ficin | Ficus proteinase | Enzybel, Waterloo, |
| | | Belgium |
| Xtrase | Papain | Enzybel, Waterloo, |
| | | Belgium |
| Performase | Papain | Enzybel, Waterloo, |
| | | Belgium |

The aqueous legume suspension containing the coagulating enzyme is maintained at the thermal treatment temperature, or enzyme treatment temperature, when relevant, for a coagulating duration to provide the coagulated legume suspension. The coagulating duration may be chosen freely with due consideration of the enzyme used, but the coagulating duration will typically be in the range of 5 minutes to 120 minutes, e.g. in the range of 30 minutes to 60 minutes. The duration of incubating the aqueous legume suspension with the coagulating enzyme may also depend on the temperature used during incubation and the coagulating enzyme used. The skilled person will know how to determine suitable incubation times to ensure a coagulated legume suspension based on parameters such as type of legume, type of coagulating enzyme, temperature used during coagulation and the pH of the aqueous legume suspension containing the coagulating enzyme.

The coagulating enzyme in the coagulated legume suspension is inactivated to provide a food product suspension. In particular, the change from the conditions where the coagulating enzyme is active to the inactivating conditions may end the coagulating duration. The coagulating enzyme may be inactivated using any method as desired and appropriate for the specific enzyme. The inactivation may thus include lowering or raising the temperature of the suspension containing the coagulating enzyme or increasing or lowering the pH. For example, a typical coagulating enzyme may be inactivated by increasing the temperature to at least 60° C., i.e. to an inactivating temperature. Treatment of milk proteins, e.g. caseins, with a rennet, e.g. a chymosin, is a well-known step in the preparation of a cheese from the milk of an animal. When a casein from the milk from a mammal is treated with rennet, the casein is denatured and precipitated to separate a cheese from a whey. Legumes contain storage proteins, but the present inventors have observed that the bulk protein from legumes, including the storage proteins, cannot be treated as casein proteins to provide a coagulate. For example, when the coagulating enzyme is a protease, excessive protease activity may degrade the protein in the legume suspension to a point where no coagulate is obtained, and correspondingly when the coagulating enzyme is a cross-linking enzyme, excessive cross-linking activity may cross-link the protein to a point where the obtained coagulate cannot meaningfully be treated further. The present inventors have now surprisingly found that by controlling the coagulating enzyme it is possible to control the enzymatic treatment to obtain a legume based coagulate. Thus, in the method of the invention, the enzymatic process is controlled, including selecting an appropriate coagulating enzyme, controlling the treatment temperature and the coagulating duration and then inactivating the coagulating enzyme, to thereby provide a coagulate that can be used as a food product. Without being bound by theory, the present inventors that the combination of controlling the coagulating enzyme, i.e. by controlling the duration and inactivating the coagulating enzyme, and using legume fruits, i.e. as an aqueous legume fruit suspension, allows an improved interaction between the products of the enzymatic treatment and non-protein components of the legume fruits to thereby provide a legume-based food product more closely resembling a milk-based cheese. Thus, the present invention provides a legume-based food product having functional properties closely resembling the functional properties of a milk-based cheese.

Without being bound by theory, the present inventors further consider that the lipid component interacts with the product of the enzymatic treatment, e.g. the protein or peptide fragments from a protease treatment or the cross-linked protein from the treatment with a cross-linking enzyme, to form a coagulate resembling a cheese mass, which may be processed further. For example, when the lipid component is contained in an amount in the range of 1% (VN) to 40% (VN) to total volume of the aqueous legume suspension and the lipid component and the enzyme is inactivated, a food product suspension containing a cheese like mass of legumes is obtained after the coagulating duration.

Also contemplated in the inactivating step is the combination of raising the temperature of the suspension containing the coagulating enzyme, followed by immediate cooling of the suspension containing the coagulating enzyme. Thus, in an embodiment, the step of inactivating the coagulating enzyme comprises increasing the temperature of the coagulated legume suspension to a temperature in the range of 60° C. to the boiling point of water, e.g. to a temperature in the range of 80° C. to the boiling point of water, followed by cooling the coagulated legume suspension to a temperature in the range of 0° C. to 15° C. The duration of time needed to increase and lower the temperature of the coagulated legume suspension generally depends on the volume of the suspension. In a particular example, the coagulated legume suspension containing the enzyme is placed in a first water bath kept at 95° C. and left in the water bath until the coagulated legume suspension is above 60° C. and transferred to a second water bath kept at 0° C. and left in the water bath until the coagulated legume suspension is below 20° C., e.g. below 15° C. The temperature of the coagulated legume suspension is monitored using any suitable thermometer, such as an infrared thermometer. Without being bound by any particular theory, the present inventors believe that the combination of an abrupt increase in temperature followed by the immediate quenching of the coagulated legume suspension, is not only efficient in inactivating the coagulating enzyme, but also results in the combined coagulation of other constituents of the legume solution, including proteins, fats, and fibres, e.g. soluble fibres, in the coagulated legume suspension. It is therefore believed that this coagulation by high temperature followed by low temperature provides a stabilising effect to the legume-based food product and results in a legume-based product having a similar texture as that of conventional milk-based cheeses. In particular, the effect of the combined high and low temperature treatment is considered to improve the meltability and viscosity of the food product. In a specific example, the legume-based food product comprises a soluble oligo- and polysaccharide fibre component, in particular a soluble oligo- and polysaccharide fibre component selected from carrageenan, agar agar, alginate, pectin and their combinations, in an amount in the range of 1 g/kg to 50 g/kg, e.g. 1 g/kg to 20 g/kg, of the wet weight of the legume-based food product. Without wishing to be bound by any particular theory, the inventors believe that meltability is achieved, when the product is heated since this may weaken the bonds in the protein network after the enzymatic treatment. This may soften the structure of legume-based food product, which also releases small pockets of liquid fat. It is contemplated that the lipid component, e.g. when added at a content in the range of 1% (VN) to 40% (VN) to total volume of the aqueous legume suspension and the lipid component, also contributes to the meltability of the food product.

It is generally believed that when the lipid component is added to the aqueous legume suspension, the lipids will adsorb to the dry matter, e.g. the legume dry matter, so that the lipid will eventually be part of the legume-based food product. However, when a soluble fibre component, e.g. carrageenan, agar agar, alginate, pectin, or their combinations, is added to the aqueous legume suspension, e.g. in the range of 0.1 g/L to 50 g/L, the soluble fibre component will aid in the adsorption of the lipids to the dry matter, which in turn provides a legume-based food product having organoleptic properties closely resembling the organoleptic properties of a cheese prepared from milk, e.g. cow's milk. The improved organoleptic properties are particularly relevant when the aqueous legume suspension is cooled, especially cooled quickly, from a high temperature, e.g. a temperature of at least 60° C., to a low temperature, e.g. a temperature of up to 20° C. Thus, in an example, the method of the invention comprises the steps of adding a soluble fibre component, e.g. carrageenan, agar agar, alginate, pectin, or their combinations, to the aqueous legume suspension, e.g. in the range of 0.1 g/L to 50 g/L fibre component to aqueous legume suspension, and inactivating the coagulating enzyme by increasing the temperature of the coagulated legume suspension to a temperature in the range of 60° C. to the boiling point of water followed by cooling the coagulated legume suspension to a temperature in the range of 0° C. to 15° C. to provide the food product suspension.

In order to provide the legume-based food product, liquid is removed from the food product suspension. In the context of the present disclosure, a food product suspension is a legume-based food product suspension containing a mixture of a liquid fraction and a coagulated legume-based food product fraction. The removal of liquid may be done using conventional systems, such as food grade cloths or a press, including but not limited to cheesecloths and cheese presses. The liquid removed in the process may also be referred to as “whey”, although it is to be understood that the whey of the present invention has a different composition from whey from the manufacture of cheese from cow's milk. The step of removing liquid from the food product suspension may also be referred to as draining the food product suspension. It is to be understood that the water is not removed completely from the legume-based food product and that the legume-based food product thus prepared still has a content of water. The amount of water to be removed from the food product suspension can be decided based on the desired properties of the legume-based food product. In particular, the legume-based food product generally has a water content in the range of 40 g/100 g to 60 g/100 g of the wet weight of the legume-based food product. In the present context, the wet weight of the legume-based food product is determined by weighing the legume-based food product after removal of the water from the food product suspension, in particular the legume-based food product is weighed when having the desired properties.

The legume fruit contains the oligo- and polysaccharides which may be found as soluble or insoluble fibres. One example of a soluble fibre is the raffinose family oligosaccharides. In an embodiment, an oligosaccharide fibre component is added to the aqueous legume suspension in an amount of the oligosaccharide fibre component to the aqueous legume suspension in the range of 1 g/kg to 50 g/kg, e.g. 1 g/kg to 20 g/kg. The oligosaccharides which are added to the aqueous legume suspension may be selected from raffinose, stachyose, ciceritol and verbascose. Without being bound by any particular theory, it is considered that the addition of an oligosaccharide component to the aqueous legume suspension results in a further stabilisation of the legume suspension during the manufacturing process.

The process of the present invention provides a food product from a legume-based material, which food products may undergo further processing to yield various legume-based food products resembling conventional milk-based products. In an embodiment, the manufacturing process further comprises the step of adding a lactic acid bacterium to the legume-based food product and fermenting the legume-based food product with the lactic acid bacterium. The lactic acid bacterium, when used, should be added after the step of removing liquid from the food product suspension. It is especially preferred that a lactic acid bacterium is not added during the coagulating duration when the aqueous legume suspension is being coagulated using the coagulating enzyme. The present inventors have found that if a lactic acid bacterium is added together with the coagulating enzyme, appropriate coagulation cannot be achieved. Without being bound by theory, the present inventors believe that the coagulating enzyme can interact with lactic acid bacterium and thereby lower the activity of the lactic acid bacterium and at the same time lower the activity of the coagulating enzyme. This has been found to be relevant both when the coagulating enzyme is a protease and a transglutaminase. In a specific example of the process, no lactic acid bacterium is added during the coagulating duration, and the coagulating enzyme is a protease. In another example of the process, no lactic acid bacterium is added during the coagulating duration, and the coagulating enzyme is a transglutaminase.

One or more lactic acid bacteria may be added to the legume-based food product for the fermentation. The lactic acid bacterium may be selected from the group consisting of Lactobacillus and Bifidobacterium species. The lactic acid bacteria may also be selected from conventional lactic acid bacterial strain used in dairy technology, in particular for cheese production. Bifidobacterium has a habitat that overlaps with LAB, and it has a metabolism that produces lactic acid as a primary end-product of fermentation. Accordingly, lactic acid bacteria also refer to Bifidobacterium in the context of the present disclosure. Among species of Bifidobacterium, the following can be preferred: B. adolescentis, B. breve, B. longum, B. animalis, B. infantis, B. thermophilum, B. bifidum and B. lactis. Additionally, preferred lactic acid bacteria include, but are not limited, to Streptococcus thermophilus, Lactobacillus acidophilus, Lactobacillus delbrueckii subsp. bulgaricus, Bifidobacterium animalis subsp. lactis, Lactococcus lactis ssp. lactis, Lactococcus lactis ssp. cremoris, Lactococcus lactis ssp. lactis biovar. diacetylactis, Leuconostoc ssp. mesonteroides, Lactobacillus casei, and any combination thereof.

The invention also relates to a legume-based food product. The legume-based food product is obtainable in the disclosed embodiments of the process of the invention. Thus, in another aspect, the invention relates to a legume-based food product. The legume-based food product of the present disclosure can generally be described as having a water content and a content of dry-matter. The dry-matter components may be described in terms of the dry-matter content of the legume-based food product, or all components, including the water content, of the legume-based food product may be described relative to the wet weight of the legume-based food product. The legume-based food product comprises a particulate legume component comprising enzymatically coagulated legume protein and soluble oligosaccharides and/or polysaccharide fibres from the legume fruit in the range of 50 g/kg to 250 g/kg of the wet weight of the legume-based food product, a lipid component in the range of 100 g/kg to 400 g/kg of the wet weight of the legume-based food product, and optionally also a fibre component, in particular an additional fibre component compared to the fibres contained in the legume fruit, in the range of 1 g/kg to 50 g/kg of the wet weight of the legume-based food product, and water in the range of 40 g/100 g to 60 g/100 g of the wet weight of the legume-based food product. The particulate legume fruit component comprises protein and other components, e.g. soluble, and possibly also insoluble, oligosaccharides and/or polysaccharide fibres, but regardless of the exact content of the particulate legume fruit component, the weight of the particulate legume fruit component includes proteins and other components, i.e. at least soluble oligosaccharides and/or polysaccharide fibres. The effects obtained in the process of the disclosure are reflected equally in the legume-based food product. Thus, the present invention provides a legume-based food product having functional properties, such as meltability, stretch, and firmness, more closely resembling the functional properties of a milk-based cheese. The legume-based food product in particular has a meltability which may be defined based on its ability to soften or liquefy when subjected to heat. The legume-based food product may also be defined by its stretch, meltability, viscosity or a combination of these. The legume-based food product may be defined as having a viscosity and meltability resembling that of its counterpart conventional milk-based cheese.

In an embodiment, the legume-based food product has been enzymatically coagulated by a cross-linking enzyme or a protease.

In an embodiment, the soluble oligo- and polysaccharide fibre component of the legume-based food product is selected from carrageenan, agar agar, alginate, pectin, and their combinations.

Any embodiment of the method of the invention may be used in any embodiment of the legume-based food product aspect of the invention, and any advantage for a specific embodiment of the method applies equally when an embodiment is used in any embodiment of the legume-based food product, and vice versa.

### BRIEF DESCRIPTION OF THE FIGURES

The above, as well as additional objects, features, and advantages of the present invention is better understood through the following illustrative and non-limiting detailed description of embodiments of the present invention, with reference to the appended drawings, wherein:

FIG. 1 is a flowchart for the process of manufacturing the legume-based food product,

FIG. 2a shows the composition of a cream cheese analogue of the invention;

FIG. 2b shows the composition of a commercial cream cheese;

FIG. 2c shows the composition of a brie analogue of the invention;

FIG. 2d shows the composition of a commercial brie;

FIG. 3 depicts a cheese cake made from the cream cheese analogue of the invention;

FIG. 4 depicts a brie analogue of the invention;

FIG. 5 depicts a firm cheese analogue of the invention.

### DETAILED DESCRIPTION

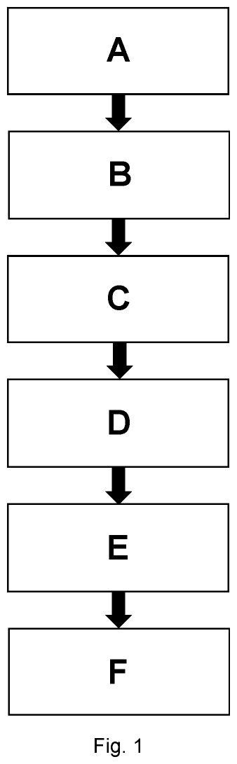

FIG. 1 shows a flowchart for the process of manufacturing the legume-based food product. First, the aqueous legume suspension is provided (A). The aqueous legume suspension may be provided as a commercially available legume suspension, e.g. in the form of a legume-based drink, such as e.g. soy drink. The aqueous legume suspension may also be prepared as part of the manufacturing process for the legume-based food product, in which case the steps of preparing the aqueous legume suspension is carried out prior to (A). Next, a lipid component is added to the aqueous legume suspension (B). At this step, a sugar component and/or citric acid may be added to aqueous legume suspension containing the lipid component. The mixture of (B) may be poured into a cheese vat. Next, the temperature of the aqueous legume suspension of step (B) is adjusted to a thermal treatment temperature (C). Then, a coagulating enzyme is added to the aqueous legume suspension and the aqueous legume suspension containing the coagulating enzyme is maintained for a coagulating duration to provide a coagulated legume suspension (D). The maintaining or incubation of the aqueous legume suspension containing the coagulating enzyme results in a coagulated legume suspension and thereby formation of a curd. Next, the coagulating enzyme in the coagulated legume suspension is inactivated (E), e.g. by heat shocking, to provide a food product suspension. The inactivation of the coagulating enzyme in the coagulated legume suspension may comprise cooling following the inactivation by heating. Next, liquid is removed from the food product suspension to provide the legume-based food product (F). The removal of liquid may be carried out in moulds, e.g. conventional cheese moulds, and the liquid may be removed by pressing the food product suspension in the mould. The legume-based food product may be subjected to further treatment, e.g. fermentation using suitable bacteria, salting, and maturation.

### EXAMPLES

### Example 1—Preparing an Aqueous Legume Suspension

Soybeans were selected as a legume for preparing an aqueous legume suspension, a “soy milk”. The soybeans were obtained from a local supplier. In the process, 1 kg of yellow soybeans are soaked for 12 hours in alkaline water (0.25% bicarbonate) at room temperature. Then the beans were dehulled, before being blanched in alkaline water (0.25% bicarbonate) for 25 minutes. They were then rinsed with 50° C. water, and the blanched soybeans were removed from the water. The blanched soybeans were suspended in 9 L of water before blending the soybeans in the water, until a homogenous consistency was achieved. Thus, the blanched soybeans were suspended in water at 10 wt % compared to the original dry weight of the legume fruit before suspending in water.

This provided a suspension suited for treating in the following steps of the present method. However, for subsequent use as a legume suspension, the soymilk was poured through a cheese cloth, to remove insoluble fibres and other insoluble components; for soybeans the insoluble components are generally referred to as okara.

### Example 2—Manufacturing a Legume-Based Food Product Resembling a Firm-Curd Cheese

Enzymatic treatment: A legume-based milk composed of 20% fat (v/v), 2% sucrose and soy milk with 3.7% protein were poured in a 500 ml container and heated in a 55° C. water bath for 25 minutes. The cross-linking enzyme transglutaminase was added in proportion 1 g per 100 ml and mixed by thorough shaking of the container. Hereafter, the mixture was incubated in a water bath at a temperature to 50° C. for 50 minutes. After the incubation, the enzymatically treated mixture was heat-shocked in a water bath at 95° C. for 25 minutes. The heat-shocked mixture was then transferred to an ice bath and left to incubate therein until the mixture was below 20° C. Separation of liquid phase and coagulated product: The content of the container was poured through a cheese-cloth and left to drip until water/whey was no longer flowing freely from the cloth. The coagulated legume-based food product remaining in the cloth was squeezed to remove any remaining liquid. Alternatively, the coagulated food product may also be pressed using a conventional cheese press. When using the cheese press, the coagulated food product was first transferred to a cheese cloth and thereafter to a mould for the pressing. Prior to pressing in the mould, the cheesecloth was closed around the coagulated food product to minimize spillage.

Fermentation: A bacterial brine was prepared by adding a bacterial culture to 50 ml water. Using a small volume for preparing the bacterial brine enables measuring out the small quantities needed for the bath. The bacterial brine used to manufacture the legume-based food product resembling a firm-curd cheese contained the following concentration of bacteria: 2 grams per litre of ABT-culture (Streptococcus thermophilus, Lactobacillus delbrückii subsp. lactis, Lactobacillus acidophilus, Bifidobacterium lactis), 0.08 grams per litre of Lactobacillus casei. Bacterial cultures were purchased from hjemmeriet.dk. After 2 days in bacterial brine at 12,4° C., the fermented coagulated food product was taken out and left to drip off. If the fermented coagulated food product was previously in a cheesecloth it was transferred to cheese moulds at this stage.

Salting and maturation: A salt brine with 13% sodium chloride was prepared and the fermented legume-based food product was dunked in the salt brine and left to incubate for 5 minutes at room temperature. Following this, the food product was left to drip off before being transferred to a maturation room/chamber at 12,4° C. for five days. After the five days' maturation time, the food product displayed a firm-curd cheese like appearance, texture and taste.

### Example 3—Manufacturing a Legume-Based Food Product Resembling a Cream Cheese

Enzymatic treatment: A legume-based milk composed of 20% fat (v/v), 2% sucrose and soy milk with 3.7% protein were poured in a 500 ml container and heated in a 55° C. water bath for 25 minutes. Fromase, a protease produced by the soil fungus Rhizomucor miehei, was added in proportion 150 μL per 100 ml and mixed by thorough shaking of the container. Hereafter, the mixture was incubated in a water bath at a temperature to 50° C. for 50 minutes. After the incubation, the enzymatically treated mixture was heat-shocked in a water bath at 95° C. for 25 minutes. The heat-shocked mixture was then transferred to an ice bath and left to incubate therein until the mixture was below 20° C.

Separation of liquid phase and coagulated product: The content of the container was poured through a cheese-cloth and left to drip until water/whey was no longer flowing freely from the cloth. The coagulated product remaining in the cloth was squeezed to remove any remaining water. Alternatively the coagulated product may also be pressed using a conventional cheese press. When using the cheese press, the coagulated product was first transferred to a cheese cloth and thereafter to a mould for the pressing. Prior to pressing in the mould, the cheesecloth was closed around the coagulated legume-based food product to minimize spillage.

Fermentation: A bacterial brine was prepared by adding a bacterial culture to 50 ml water. The bacterial brine used to manufacture the legume-based food product resembling a cream cheese contained the following concentration of bacteria: 0.06 grams per litre of STI 12 (Streptococcus thermophilus), 0.08 grams per litre of ABY (Lactobacillus acidophilus, Lactobacillus delbrueckii subsp. bulgaricus, Bifidobacterium animalis subsp. lactis), 0.08 grams per litre of DL (Lactococcus lactis ssp. lactis, Lactococcus lactis ssp. cremoris, Lactococcus lactis ssp. lactis biovar. diacetylactis and Leuconostoc ssp. mesonteroides) and 0.08 grams per litre of Lactobacillus casei. Bacterial cultures were purchased from hjemmeriet.dk. After 2 days in bacterial brine at 12,4° C., the fermented coagulated legume-based food product was taken out and left to drip off. If the fermented coagulated food product was previously in a cheesecloth it was transferred to cheese moulds at this stage.

Salting and maturation: A salt brine with 13% sodium chloride was prepared and the fermented legume-based food product was dunked in the salt brine and left to incubate for 5 minutes at room temperature. Following this, the food product was left to drip off before being transferred to a maturation room/chamber at 12,4° C. for five days. After the five days' maturation time, the food product displayed a cream cheese like appearance, texture and taste.

### Example 4—Comparison with Commercial Milk-Based Cheeses

A cream cheese analogue and a brie analogue were prepared according to the invention. Both cheese analogues were prepared from commercially available soy drink (obtained from NATURLI' Foods A/S, Vejen, Denmark) as the legume fruit suspension. Sunflower oil was selected as the lipid component, and this lipid component was added to and mixed with the legume fruit suspension. At this stage, the lipid component was generally distributed as droplets in the legume fruit suspension where the naturally occurring carbohydrates and proteins of the legume fruit are believed to maintain an appropriate distribution of the lipid droplets in the liquid. The legume fruit suspension for the brie analogue was further supplemented with beta-glucan and carrageenan. The legume fruit suspensions with the lipid component are referred to as milk analogues in the following. Samples were withdrawn from each of the two milk analogues and analysed for dry-matter (DM) contents. The DM contents of the milk analogues are shown in Table 2, where the DM contents are expressed in g per 100 g of the weight of the milk analogues.

TABLE 2
Compositions of milk analogues

| | Cream cheese analogue (g) | Brie analogue (g) |
|---|---|---|
| Water | ~81 | ~71 |
| Total dry matter | ~19 | ~29 |
| Protein | 3.3 | 2.9 |
| Non-protein DM | ~15.7 | ~26.1 |
| Fat | 11.8 | 21.6 |
| Carbohydrate | 3.1 | 3.9 |
| Ash | Not analysed | Not analysed |

The milk analogues were heated to a temperature of 35° C. representing both the thermal treatment temperature and the enzyme treatment temperature and maintained at this temperature over the coagulating duration before cooling the milk analogues to the enzyme treatment temperature and adding fromase as the coagulating enzyme. The milk analogues were maintained at the enzyme treatment temperature over a coagulating duration of 60 minutes before inactivating the coagulating enzyme by increasing the temperature to an inactivating temperature 70° C.

The liquid was drained from enzyme treated milk analogues to provide the coagulate representing the legume-based food products of the invention. Samples were taken from the coagulates and analysed for contents of water, total DM and protein. The results are presented in Table 3, where the DM contents are shown in g per 100 g of the wet weight of the coagulates.

TABLE 3
Compositions of coagulates

| | Cream cheese analogue (g) | Brie analogue (g) |
|---|---|---|
| Water | 50.2 | 51.2 |
| Total dry matter | 49.8 | 48.8 |
| Protein | 13.1 | 9.4 |
| Non-protein DM | 36.7 | 39.4 |

The legume-based food products of the invention can be compared to commercial cheeses based on cow's milk, and in the comparison below, the legume-based food products are compared to data available from Arla Foods (Viby J, Denmark). The compositions of three commercial cheese types from Arla Foods are shown in Table 4.

TABLE 4
Compositions of commercial cheese types

| | Cream cheese (g) | White mould (g) | Danbo (g) |
|---|---|---|---|
| Water | 65.5 | 45 | 49.5 |
| Protein | 4.5 | 14 | 22 |
| Non-protein DM | 30 | 41 | 28.5 |
| Fat | 25 | 39 | 26 |
| Carbohydrate | 3 | 0.5 | 0.5 |
| Salt | 0.8 | 1.5 | 1.7 |
| Minerals | Not specified | Not specified | Not specified |

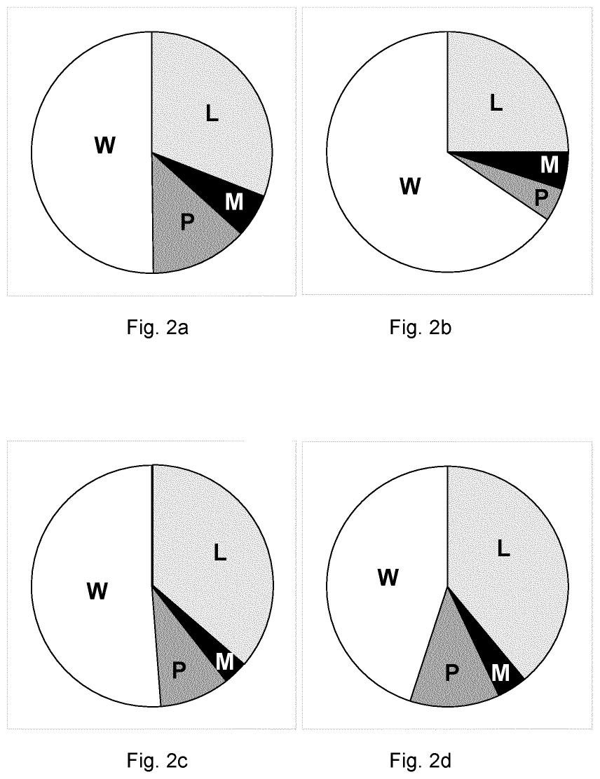

The cream cheese and the white mould cheese of Table 4 are comparable to the cream cheese analogue and the brie analogue, respectively, of Table 3. Fat was not determined in the analyses for Table 3, as protein and dry matter were the focus, but it is believed that as there were no visible fat droplets on the surface of the liquid drained from the coagulates, the coagulate has a composition with respect to protein and fat corresponding to the composition of the milk analogue. Based on the understanding that the fat lost in the whey represents a negligible amount, the fat content should be 30.9% and 36.3% for the cream cheese and brie analogue, respectively, leaving 5.8 and 3.1% dry matter to account for carbohydrates, salt and minerals. This allows a comparison of the composition of dairy cream cheese and brie-type with cheese analogues of the present invention, and these comparison are illustrated in FIG. 2, where panel a shows the composition of a cream cheese analogue of the invention, panel b shows the composition of a cream cheese from Arla Foods; panel c shows the composition of a brie analogue of the invention, and panel d shows the composition of a brie cheese from Arla Foods. In FIG. 2, “L” shows fat, “M” shows remaining dry matter, “P” shows protein, and “W” shows water.

Cow's milk typically has a total dry matter of around 13% and it is this dry matter that is concentrated when making cheese, with only fractions being lost into the whey, together with the majority of the water. Thus, curd cheeses commonly have a dry matter content of around 50%, which is lowered with the drying process that happens during aging. In general terms, components of a milk that are not made into cheese are lost to the whey. For a cheese manufacturing process based on cow's milk, the dry matter of whey is typically around 6%, with 4.5% lactose, 0.6% protein, 0.05% fat and 0.8% ash. This means that of the initial protein, around 0.5% is lost, mainly in the form of whey proteins (0.6% of the initial milk), and the remaining 2.9% protein is concentrated in the cheese.

In conclusion, the present invention obtains a higher yield, while losing less dry matter to the liquid after draining the coagulate, and also a content of water, protein, and fat content entirely comparable to dairy cheeses.

### Example 5—Cheesecake Made from Cream Cheese Analogue

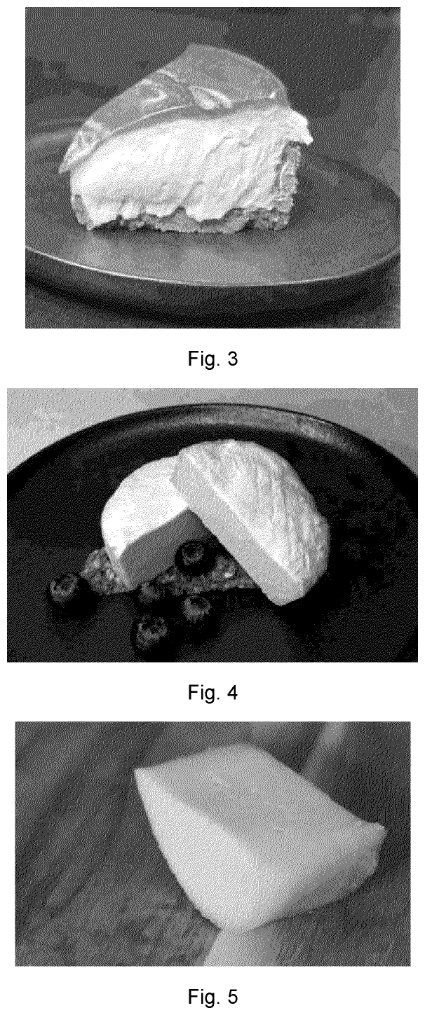

A ‘cheesecake’ was made from the cream cheese analogue prepared in Example 4. Specifically, a crust was prepared by crushing digestive biscuits and mixing with melted plant-based butter, and the crust was then spread in an appropriate container before placing in the fridge for 30 min. The cream cheese analogue was then included in a filling that was applied to the crust. A strawberry gel was then applied to finalise the cheesecake. A slice of the cheesecake was cut before depicting in FIG. 3.

### Example 6—Finalising Brie Analogue

The brie analogue prepared in Example 4 was salted before inoculating with a culture of Penicillium camemberti, and then finally ageing for two weeks. The fermented brie analogue had the visual appearance of a brie prepared from cow's milk, as shown in FIG. 4, and due to the fermentation also had a flavour to meaningfully classify as a ‘brie analogue’.

### Example 7—Firm Cheese Analogue

A firm cheese analogue was prepared as outlined below.

Enzymatic treatment: A legume-based milk composed of 15% fat (v/v), 2% sucrose, 1% carrageenan and soy milk with 3.7% protein were poured in a 500 ml container and heated in a 45° C. water bath for 25 minutes. The enzyme fromase was added in a 10 microL per 100 mL. Hereafter, the mixture was incubated in a water bath at a temperature to 40° C. for one hour. During incubation, the cheese curd was cut in one centimetre cubes. After the incubation, the enzymatically treated mixture was heat-shocked in a water bath at 95° C. for 25 minutes. The heat-shocked mixture was then transferred to an ice bath and left to incubate therein until the mixture was below 20° C.

Separation of liquid phase and coagulated product: The content of the container was poured through a cheesecloth and left to drip until water/whey was no longer flowing freely from the cloth. The coagulated legume-based food product remaining in the cloth was squeezed to remove any remaining liquid. Alternatively, the coagulated food product may also be pressed using a conventional cheese press. When using the cheese press, the coagulated food product was first transferred to a cheese cloth and thereafter to a mould for the pressing. Prior to pressing in the mould, the cheesecloth was closed around the coagulated food product to minimize spillage.

Fermentation: A bacterial brine was prepared by adding a bacterial culture to 50 ml water. Using a small volume for preparing the bacterial brine enables measuring out the small quantities needed for the bath. The bacterial brine used to manufacture the legume-based food product resembling a firm-curd cheese contained the following concentration of bacteria: 2 grams per litre of ABT-culture (Streptococcus thermophilus, Lactobacillus delbrückii subsp. lactis, L. acidophilus, Bifidobacterium lactis), 0.08 grams per litre of L. casei. Bacterial cultures were purchased from hjemmeriet.dk. After 1 day in bacterial brine at 13° C., the fermented coagulated food product was taken out and left to drip off. If the fermented coagulated food product was previously in a cheesecloth it was transferred to cheese moulds at this stage.

Salting and maturation: A salt brine with 18% sodium chloride was prepared and the fermented legume-based food product was dunked in the salt brine and left to incubate for 10 minutes at room temperature. Following this, the food product was left to drip off before being transferred to a maturation room/chamber at 13° C. for 8 weeks. After the eight weeks' maturation time, the food product displayed a firm-curd cheese like appearance, texture, taste and good slicability. The firm-curd cheese is depicted in FIG. 5 after cutting in halves.

What is claimed is:

1. A process for the manufacture of a legume-based food product, the process comprising:
providing an aqueous legume fruit suspension having a dry-matter content in the range of 50 g/L to 250 g/L;
adding a lipid component to the aqueous legume fruit suspension in an amount of the lipid component in the range of 1% (V/V) to 40% (V/V) to total volume of the aqueous legume fruit suspension and the lipid component;
adjusting the temperature of the aqueous legume fruit suspension to a thermal treatment temperature in the range of 30° C. to 90° C.;
adding a coagulating enzyme to the aqueous legume fruit suspension and maintaining the aqueous legume fruit suspension containing the coagulating enzyme for a coagulating duration in the range of 5 minutes to 120 minutes to provide a coagulated legume fruit suspension;
inactivating the coagulating enzyme in the coagulated legume fruit suspension to provide a food product suspension; and
removing liquid from the food product suspension to provide the legume-based food product.

2. The process according to claim 1, wherein providing an aqueous legume fruit suspension comprises:
providing a legume fruit;
disrupting the legume fruit;
suspending the legume fruit in water to provide a legume fruit suspension; and
heating the legume fruit suspension to a temperature in the range of 50° C. to the boiling point of water for a hydrating duration to provide the aqueous legume fruit suspension.

3. The process according to claim 1, wherein the coagulating enzyme is a cross-linking enzyme or a protease.

4. The process according to claim 1, wherein the aqueous legume fruit suspension is maintained at the thermal treatment temperature for a thermal treatment duration, before adding the coagulating enzyme to the aqueous legume fruit suspension.

5. The process according to claim 1, further comprising adjusting the temperature of the aqueous legume suspension from the thermal treatment temperature to an enzyme treatment temperature, which enzyme treatment temperature is in the range of 10° C. to 70° C. and different from the thermal treatment temperature.

6. The process according to claim 1, wherein inactivating the coagulating enzyme comprises increasing the temperature of the coagulated legume fruit suspension to a temperature in the range of 60° C. to the boiling point of water followed by cooling the coagulated legume fruit suspension to a temperature in the range of 0° C. to 15° C.

7. The process according to claim 1, further comprising adding a lactic acid bacterium to the legume-based food product and fermenting the legume-based food product with the lactic acid bacterium.

8. The process according to claim 1, further comprising adding a soluble oligo- and polysaccharide fibre component to the aqueous legume fruit suspension.

9. The process according to claim 8, wherein the soluble oligo- and polysaccharide fibre component is selected from carrageenan, agar agar, alginate, pectin, and their combinations.

10. The process according to claim 1, wherein the lipid component is a liquid oil at ambient temperature.

11. The process according to claim 5, wherein the thermal treatment temperature is in the range of 70° C. to 90° C., and the enzyme treatment temperature is in the range of 30° C. to 70° C.

12. A legume-based food product comprising:
a particulate legume fruit component, comprising enzymatically coagulated legume protein and soluble oligosaccharides and/or polysaccharide fibres from the legume fruit in the range of 50 g/kg to 250 g/kg of the wet weight of the legume-based food product;
a lipid component in the range of 100 g/kg to 400 g/kg of the wet weight of the legume-based food product; and
water in the range of 40 g/100 g to 60 g/100 g of the wet weight of the legume-based food product.

13. The legume-based food product according to claim 12, wherein the legume-based food product has been enzymatically coagulated by a cross-linking enzyme or a protease.

14. The legume-based food product according to claim 12, further comprising an additional fibre component in the range of 1 g/kg to 50 g/kg of the wet weight of the legume-based food product.

15. The legume-based food product according to claim 14, wherein the additional fibre component is a soluble oligo- and polysaccharide fibre component selected from carrageenan, agar agar, alginate, pectin, and their combinations.

16. An aqueous legume suspension comprising:
a dry-matter content of blanched and disrupted legume fruits in the range of 50 g/L to 250 g/L,
a vegetable oil lipid component in the range of 150 g/L to 360 g/L, and
an additional fibre component compared to the fibres contained in the legume fruit in the range of 0.1 g/L to 50 g/L.

17. The aqueous legume suspension of claim 16, wherein the additional fibre component is a soluble oligo- and polysaccharide fibre component.

18. The aqueous legume suspension of claim 17, wherein the additional fibre component is selected from agar agar, guar gum, alginate, amylose, starch, xanthan gum, pectin and gellan gum and any combination thereof, or from agar, alginate, pectin and carrageenan and any combination thereof.
